(19) United States
(12) Patent Application Publication
(10) Pub. No.: US 2021/0192869 A1
(43) Pub. Date: Jun. 24, 2021

(54) Standard for the Creation, Storing, Transmission, Receiving, and Processing of Vehicle Location, Speed, Heading, and Environmental Conditions Data as Well as Intended, Unintended, Anticipated, and Predicted Changes to that Data

(71) Applicant: Michael Arthur Conley, Auburn, CA (US)

(72) Inventor: Michael Arthur Conley, Auburn, CA (US)

(21) Appl. No.: 16/724,348

(22) Filed: Dec. 22, 2019

(51) Int. Cl. G07C 5/08; G07C 5/00

(52) U.S. Cl. CPC G07C 5/085; G07C 5/008

(57) ABSTRACT

A standard for the creation, storage, transmission, processing, and usage of data records that document the current, proposed, and indicated location, speed, heading, and environmental conditions regarding a vehicle, whether the vehicle is on land, on water, submerged in water, or above ground. These records can be used by the vehicle, other vehicles, as well as public and private services, to aid in traffic control, avoidance of obstacles, hazards, and challenging weather, collision avoidance, event reconstruction, manual and automated navigational decisions, and to support the fully or partially autonomous operation of vehicles.

### BACKGROUND

### Prior Art

The following is a tabulation of some prior art that presently appears relevant:

| Patent Number | Issue Date | Patentee |
|---|---|---|
| None Found | | |

### BACKGROUND OF THE INVENTION

With advancements in vehicles, new or increased risks of personal injury, death, and property damage have presented. New protective mechanisms have been implemented to lessen the impacts of these risks, such as airbags, seatbelts, impact absorbing equipment, and many others which have been implemented on a variety of forms of transportation. Additionally, there have been a number of technologies designed to lessen the risk of an unintended occurrence, such as anti-lock braking systems, traffic collision avoidance systems, lane departure warning systems, dead man's switches, radar and laser systems, and other mechanisms to prevent the accident or impact from ever occurring.

The ability of a vehicle, whether on land, on water, under water, or above the ground, to automatically transmit and/or store its current location, its heading, its relative speed, and environmental data, as well as intended, unintended, anticipated, and/or predicted changes to its location, speed, and heading, combined with that vehicle's ability to receive the same from other nearby vehicles and services designed to process such information, will aid in giving notice to other vehicles allowing the appropriate actions, whether manual or automatic, to be taken based on that information.

To facilitate this, vehicles must understand how to communicate with other vehicles, transmitting, receiving, and storing such information in a manner that makes it understandable and actionable.

The value of this capability would be significant. This would provide a mechanism for vehicles to provide notice, in advance and/or in real time, of current, intended, unintended, anticipated, and predicted changes, and to receive the same from other vehicles, as well as storing said information. This could be used for a variety of purposes, not the least of which are collision avoidance, evasive actions, determination of traffic congestion, avoidance of obstacles, hazards, and challenging weather, and retrieval of historical information for event reconstruction, determination of actions, and an understanding of the factors at play in a particular situation, as well as to support the fully or partially autonomous operation of vehicles.

### SUMMARY OF THE INVENTION

This invention seeks to provide a framework for vehicles of various types, from various manufacturers, in various jurisdictions, having various capabilities, and serving various purposes, to create, transmit, store, receive, and process information about vehicle location, speed and heading, and environmental conditions, as well as intended, unintended, anticipated, and predicted changes to the vehicle's location, speed, and heading. This will provide the ability for a vehicle to record its own location, speed, heading information, and environmental conditions, as well as receive, store, and take actions based on information received from other vehicles about their location, speed, heading, and environmental conditions, along with intended, unintended, anticipated, and predicted changes to location, speed, and heading, as well as support the fully or partially autonomous operation of vehicles.

In short, this invention will provide a standard way for various vehicles to create, store and communicate motion and environmental information for its own use, the use of other vehicles, and others involved with the many aspects of handling vehicle travel, traffic, collision avoidance, and route determination, as well as support the fully or partially autonomous operation of vehicles.

### DETAILED DESCRIPTION

In order to allow for the creation, storage, transmission, and processing of information regarding the location, speed, heading, and environmental conditions of a vehicle, along with intended, unintended, anticipated, and predicted changes to location, speed, and heading, a standard for communication must be established, to let vehicles communicate directly or alternatively to allow them to interpret the data being transmitted from other vehicles, as well as allowing others involved with the many aspects of handling vehicle travel, traffic, collision avoidance, and route determination to properly utilize such information. Additionally, this standard will support the fully or partially autonomous operation of vehicles.

To allow for the formatting of data in a manner that is able to be created, stored, transmitted, and/or received by other vehicles and others, the data must be assembled in a standard format and suitable for high speed and high rate creation, storage, transmission and processing. At a high level, the data elements, depending on the mode of travel and other factors, will consist of some or all of the following:

current timestamp (TIME), vehicle identifier (VEID), current latitude coordinate (CLAC), current longitude coordinate (CLOC), current elevation (CELV), current true north bearing (CTAB), current magnetic north bearing (CMAB), current zenith angle (CZEN), current speed (CSPD), current temperature (CTMP), current humidity (CHUM), current precipitation (CPRE), current barometric pressure (CBMP), current hydrostatic pressure (CHSP), current horizontal wind speed (CHWS), current horizontal wind heading (CHWH), current vertical wind speed (CVWS), current vertical wind heading (CVWH), current horizontal current speed (CHCS), current horizontal current heading (CHCH), current vertical current speed (CVCS), current vertical current heading (CVCH), current roll (CROL), current pitch (CPTC), current yaw (CYAW), current acceleration rate (CACC), current destination latitude coordinate (CDLA), current destination longitude coordinate (CDLO), current destination elevation (CDEL), current estimated time of arrival (CETA), proposed latitude coordinate (PLAT), proposed latitude time (PLTA), proposed latitude latitude coordinate (PLTB), proposed latitude longitude coordinate (PLTC), proposed latitude elevation value (PLTD), proposed latitude priority (PLTP), proposed longitude coordinate (PLON), proposed longitude time (PLNA), proposed longitude latitude coordinate (PLNB), proposed longitude longitude coordinate (PLNC), proposed longitude elevation value (PLND), proposed longitude priority (PLNP), proposed elevation (PELV), proposed elevation time (PELA), proposed elevation latitude coordinate (PELB), proposed elevation longitude coordinate (PELC), proposed elevation elevation value (PELD), proposed elevation priority (PELP), proposed true north bearing (PTNB), proposed true north bearing time (PTBA), proposed true north bearing latitude coordinate (PTBB), proposed true north bearing longitude coordinate (PTBC), proposed true north bearing elevation value (PTBD), proposed true north bearing priority (PTBP), proposed magnetic north bearing (PMAB), proposed magnetic north bearing time (PMBA), proposed magnetic north bearing latitude coordinate (PMBB), proposed magnetic north bearing longitude coordinate (PMBC), proposed magnetic north bearing elevation value (PMBD), proposed magnetic north bearing priority (PMBP), proposed zenith angle (PZEN), proposed zenith angle time (PZNA), proposed zenith angle latitude coordinate (PZNB), proposed zenith angle longitude coordinate (PZNC), proposed zenith angle elevation value (PZND), proposed zenith angle priority (PZNP), proposed speed (PSPD), proposed speed time (PSDA), proposed speed latitude coordinate (PSDB), proposed speed longitude coordinate (PSDC), proposed speed elevation value (PSDD), proposed speed priority (PSDP), proposed roll (PROL), proposed roll time (PRLA), proposed roll latitude coordinate (PRLB), proposed roll longitude coordinate (PRLC), proposed roll elevation value (PRLD), proposed roll priority (PRLP), proposed pitch (PPTC), proposed pitch time (PPCA), proposed pitch latitude coordinate (PPCB), proposed pitch longitude coordinate (PPCC), proposed pitch elevation value (PPCD), proposed pitch priority (PPCP), proposed yaw (PYAW), proposed yaw time (PYWA), proposed yaw latitude coordinate (PYWB), proposed yaw longitude coordinate (PYWC), proposed yaw elevation value (PYWD), proposed yaw priority (PYWP), proposed acceleration rate (PACC), proposed acceleration time (PALA), proposed acceleration latitude coordinate (PALB), proposed acceleration longitude coordinate (PALC), proposed acceleration elevation value (PALD), proposed acceleration priority (PALP), indicated latitude coordinate (ILAC), indicated longitude coordinate (CLOC), indicated elevation (CELV), indicated true north bearing (ITAB), indicated magnetic north bearing (IMAB), indicated zenith angle (IZEN), indicated speed (ISPD), indicated roll (IROL), indicated pitch (IPTC), indicated yaw (IYAW), indicated acceleration rate (IACC).

TIME will represent the current time as used by the commonly accepted geographic coordinate system, as well as other available instrumentation, specified with sufficient precision to support the method of travel for which information is being monitored and the frequency of information gathering, updating, storing, and transmission.

VEID will identify the specific vehicle for which information is being monitored. Every vehicle creating, storing, and transmitting this information will have a unique identifier.

CLAC will represent the current latitude coordinates of the vehicle as used by the commonly accepted geographic coordinate system and/or other available instrumentation to represent the location of the vehicle relative to its position on earth whether the vehicle is on land, on water, submerged in water, or above ground, specified with sufficient precision to support the method of travel for which information is being monitored and the frequency of information gathering, updating, storing and transmission.

CLOC will represent the current longitude coordinates of the vehicle as used by the commonly accepted geographic coordinate system and/or other available instrumentation to represent the location of the vehicle relative to its position on earth whether the vehicle is on land, on water, submerged in water, or above ground, specified with sufficient precision to support the method of travel for which information is being monitored and the frequency of information gathering, updating, storing and transmission.

CELV will represent the current elevation value of the vehicle as used by the commonly accepted geographic coordinate system and/or other available instrumentation to represent the elevation of the vehicle relative to sea level or some other standard to determine elevation, whether the vehicle is on land, on water, submerged in water, or above ground, specified with sufficient precision to support the method of travel for which information is being monitored and the frequency of information gathering, updating, storing and transmission.

CTAB will represent the absolute bearing of the vehicle as determined by a series of consecutive CLAC and CLOC readings, along with compass and other navigational instrumentation available to determine the heading of the vehicle relative to true geographical north whether the vehicle is on land, on water, submerged in water, or above ground, specified with sufficient precision to support the method of travel for which information is being monitored and the frequency of information gathering, updating, storing and transmission.

CMAB will represent the absolute bearing of the vehicle as determined by a series of consecutive CLAC and CLOC readings, along with compass and other navigational instrumentation available to determine the heading of the vehicle relative to magnetic north whether the vehicle is on land, on water, submerged in water, or above ground, specified with sufficient precision to support the method of travel for which information is being monitored and the frequency of information gathering, updating, storing and transmission.

CZEN will represent the zenith angle of the motion of the vehicle as determined by a series of consecutive CLAC, CLOC, and CELV readings, along with other navigational and speed measurement instrumentation available to determine the heading of the vehicle, whether the vehicle is on land, on water, submerged in water, or above ground, specified with sufficient precision to support the method of travel for which information is being monitored and the frequency of information gathering, updating, storing and transmission. Unlike the CPTC reading, the CZEN is measuring the angle of the motion of the vehicle rather than the angle of the vehicle itself.

CSPD will represent the current speed of the vehicle as determined by a series of consecutive CLAC, CLOC, CELV, and TIME readings, along with other navigational and speed measurement instrumentation available to determine the speed of the vehicle, whether the vehicle is on land, on water, submerged in water, or above ground, specified with sufficient precision to support the method of travel for which information is being monitored and the frequency of information gathering, updating, storing and transmission.

CTMP will represent the current temperature of the air, water, or surroundings of the vehicle at the vehicle's current location, as determined by instruments and/or sensors on or near the vehicle whether the vehicle is on land, on water, submerged in water, or above ground, specified with sufficient precision and frequency for the method, speed, and variability of the method of travel to support information gathering, updating, storing and transmission.

CHUM will represent the current humidity, or amount of water vapor, in the area immediately surrounding the vehicle as determined by instruments and/or sensors on or near the vehicle whether the vehicle is on land, on water, submerged in water, or above ground, specified with sufficient precision and frequency for the method, speed, and variability of the method of travel to support information gathering, updating, storing and transmission. In the event the vehicle is submerged in water or other liquid at the time of this measurement, a fixed value will be assigned to note that the vehicle is submerged.

CPRE will represent the current form of precipitation, if any, in the area immediately surrounding the vehicle, whether none, rain, snow, hail, or sleet, as determined by instruments and/or sensors on or near the vehicle whether the vehicle is on land, on water, or above ground, specified with sufficient frequency for the method, speed, and variability of the method of travel to support information gathering, updating, storing and transmission.

CBMP will represent the current barometric pressure, or atmospheric pressure, in the area immediately surrounding the vehicle as determined by instruments and/or sensors on or near the vehicle whether the vehicle is on land, on water, or above ground, specified with sufficient precision and frequency for the method, speed, and variability of the method of travel to support information gathering, updating, storing and transmission. This value is only populated if the vehicle is not submerged in water or other liquid, otherwise it will contain a value that signifies that the vehicle is submerged.

CHSP will represent the current hydrostatic pressure exerted on the exterior of the vehicle as determined by instruments and/or sensors on or near the vehicle whether the vehicle is on land, on water, submerged in water, or above ground, specified with sufficient precision and frequency for the method, speed, and variability of the method of travel to support information gathering, updating, storing and transmission. This value is only populated if the vehicle is submerged in water or other liquid, otherwise it will contain a value that signifies that the vehicle is not submerged.

CHWS will represent the speed of the horizontal wind in the area immediately surrounding the current location of the vehicle as determined by instruments and/or sensors on or near the vehicle whether the vehicle is on land, on water, or above ground, specified with sufficient precision and frequency for the method, speed, and variability of the method of travel to support information gathering, updating, storing and transmission. This value is only populated if the vehicle is not submerged in water or other liquid, otherwise it will contain a value that signifies that the vehicle is submerged.

CHWH will represent the heading of the horizontal wind in the area immediately surrounding the current location of the vehicle relative to a particular and predictable point such as magnetic north or true geographical north as determined by instruments and/or sensors on or near the vehicle whether the vehicle is on land, on water, or above ground, specified with sufficient precision and frequency for the method, speed, and variability of the method of travel to support information gathering, updating, storing and transmission. This value is only populated if the vehicle is not submerged in water or other liquid, otherwise it will contain a value that signifies that the vehicle is submerged.

CVWS will represent the speed of the vertical wind in the area immediately surrounding the current location of the vehicle as determined by instruments and/or sensors on or near the vehicle whether the vehicle is on land, on water, or above ground, specified with sufficient precision and frequency for the method, speed, and variability of the method of travel to support information gathering, updating, storing and transmission. This value is only populated if the vehicle is not submerged in water or other liquid, otherwise it will contain a value that signifies that the vehicle is submerged.

CVWH will represent the heading of the vertical wind in the area immediately surrounding the current location of the vehicle relative to a particular and predictable point such as zenith and nadir of the vehicle's current location as determined by instruments and/or sensors on or near the vehicle whether the vehicle is on land, on water, or above ground, specified with sufficient precision and frequency for the method, speed, and variability of the method of travel to support information gathering, updating, storing and transmission. This value is only populated if the vehicle is not submerged in water or other liquid, otherwise it will contain a value that signifies that the vehicle is submerged.

CHCS will represent the speed of the horizontal underwater current in the area immediately surrounding the current location of the vehicle as determined by instruments and/or sensors on or near the vehicle when submerged in water or other liquid, specified with sufficient precision and frequency for the method, speed, and variability of the method of travel to support information gathering, updating, storing and transmission. This value is only populated if the vehicle is submerged in water or other liquid, otherwise it will contain a value that signifies that the vehicle is not submerged.

CHCH will represent the heading of the horizontal underwater current in the area immediately surrounding the current location of the vehicle relative to a particular and predictable point such as magnetic north or true geographical north as determined by instruments and/or sensors on or near the vehicle when submerged in water or other liquid, specified with sufficient precision and frequency for the method, speed, and variability of the method of travel to support information gathering, updating, storing and transmission. This value is only populated if the vehicle is submerged in water or other liquid, otherwise it will contain a value that signifies that the vehicle is not submerged.

CVCS will represent the speed of the vertical underwater current in the area immediately surrounding the current location of the vehicle as determined by instruments and/or sensors on or near the vehicle when submerged in water or other liquid, specified with sufficient precision and frequency for the method, speed, and variability of the method of travel to support information gathering, updating, storing and transmission. This value is only populated if the vehicle is submerged in water or other liquid, otherwise it will contain a value that signifies that the vehicle is not submerged.

CVCH will represent the heading of the vertical underwater current in the area immediately surrounding the current location of the vehicle relative to a particular and predictable point such as zenith and nadir of the vehicle's current location as determined by instruments and/or sensors on or near the vehicle when the vehicle is submerged in water or other liquid, specified with sufficient precision and frequency for the method, speed, and variability of the method of travel to support information gathering, updating, storing and transmission. This value is only populated if the vehicle is submerged in water or other liquid, otherwise it will contain a value that signifies that the vehicle is not submerged.

CROL will represent the current degree of roll, or the rotation along the roll axis of the vehicle, from the vehicle's predefined steady equilibrium state for roll, whether the vehicle is on land, on water, submerged in water, or above ground, specified with sufficient precision to support the method of travel for which information is being monitored and the frequency of information gathering, updating, storing and transmission.

CPTC will represent the current degree of pitch, or rotation along the pitch axis of the vehicle, from the vehicle's predefined steady equilibrium state for pitch, whether the vehicle is on land, on water, submerged in water, or above ground, specified with sufficient precision to support the method of travel for which information is being monitored and the frequency of information gathering, updating, storing and transmission. Unlike the CZEN reading, the CPTC is measuring the angle of the vehicle rather than the angel of the motion of the vehicle.

CYAW will represent the current degree of yaw, or the rotation along the yaw axis of the vehicle, from the vehicle's predefined steady equilibrium state for yaw, whether the vehicle is on land, on water, submerged in water, or above ground, specified with sufficient precision to support the method of travel for which information is being monitored and the frequency of information gathering, updating, storing and transmission.

CACC will represent the change in acceleration rate of the vehicle as compared to the immediately preceding record or records, as well as other available instrumentation, whether the vehicle is on land, on water, submerged in water, or above ground, specified with sufficient precision to support the method of travel for which information is being monitored and the frequency of information gathering, updating, storing and transmission. A positive value will indicate an increase in acceleration while a negative value will indicate a decrease in acceleration.

CDLA will represent the current destination latitude coordinate, as used by the commonly accepted geographic coordinate system and/or other available instrumentation to represent the location of the vehicle relative to its position on earth whether the vehicle is on land, on water, submerged in water, or above ground, specified with sufficient precision to support the method of travel for which information is being monitored and the frequency of information gathering, updating, storing and transmission, indicating the latitude component of the final destination of the vehicle on a particular trip, at which point the vehicle intends to at least temporarily cease travel or otherwise finish a section of its planned journey. This value must be read in conjunction with the CDLO and CDEL values to get a particular destination.

CDLO will represent the current destination longitude coordinate, as used by the commonly accepted geographic coordinate system and/or other available instrumentation to represent the location of the vehicle relative to its position on earth whether the vehicle is on land, on water, submerged in water, or above ground, specified with sufficient precision to support the method of travel for which information is being monitored and the frequency of information gathering, updating, storing and transmission, indicating the longitude component of the final destination of the vehicle on a particular trip, at which point the vehicle intends to at least temporarily cease travel or otherwise finish a section of its planned journey. This value must be read in conjunction with the CDLA and CDEL values to get a particular destination.

CDEL will represent the current destination elevation value, as used by the commonly accepted geographic coordinate system and/or other available instrumentation to represent the location of the vehicle relative to its position on earth whether the vehicle is on land, on water, submerged in water, or above ground, specified with sufficient precision to support the method of travel for which information is being monitored and the frequency of information gathering, updating, storing and transmission, indicating the elevation of the final destination of the vehicle on a particular trip, at which point the vehicle intends to at least temporarily cease travel or otherwise finish a section of its planned journey. This value must be read in conjunction with the CDLA and CDLO values to get a particular destination.

CETA will represent the current estimated time of arrival at the current destination as used by the commonly accepted geographic coordinate system and/or other available instrumentation, as indicated by the values CDLA, CDLO, and CDEL, as calculated by the vehicle or otherwise calculated as an estimate for the time to arrive at the current destination.

PLAT will represent the proposed latitude coordinate of the vehicle as used by the commonly accepted geographic coordinate system and/or other available instrumentation to represent the location of the vehicle relative to its position on earth as determined by input, either from the operator of the vehicle, someone authorized to propose changes, or an automated system, to indicate any proposed change in the latitude coordinate of the vehicle from the current latitude coordinate, CLAC, whether the vehicle is on land, on water, submerged in water, or above ground, specified with sufficient precision to support the method of travel for which information is being monitored and the frequency of information gathering, updating, storing and transmission.

PLTA will represent the proposed time at which the proposed latitude coordinate, as specified in the PLAT record, is proposed to begin to be implemented, specified as a future time as used by the commonly accepted geographic coordinate system and/or other available instrumentation, specified with sufficient precision to support the method of travel for which information is being monitored and the frequency of information gathering and updating. If a particular PLTA value is not required, a value that is otherwise not valid, such as “ABC”, will be assigned to indicate that any PLTA value is acceptable.

PLTB will represent the proposed latitude coordinate, at which location when combined with the PLTC and PLTD values, the proposed latitude coordinate, PLAT, is proposed to be implemented, specified as a latitude coordinate of the vehicle, as used by the commonly accepted geographic coordinate system and/or other available instrumentation to represent the location of the vehicle relative to its position on earth whether the vehicle is on land, on water, submerged in water, or above ground, specified with sufficient precision to support the method of travel for which information is being monitored and the frequency of information gathering, updating, storing and transmission. If a particular PLTB value is not required, a value that is otherwise not valid, such as “ABC”, will be assigned to indicate that any PLTB value is acceptable.

PLTC will represent the proposed longitude coordinate, at which location when combined with the PLTB and PLTD values, the proposed latitude coordinate, PLAT, is proposed to be implemented, specified as a longitude coordinate of the vehicle, as used by the commonly accepted geographic coordinate system and/or other available instrumentation to represent the location of the vehicle relative to its position on earth whether the vehicle is on land, on water, submerged in water, or above ground, specified with sufficient precision to support the method of travel for which information is being monitored and the frequency of information gathering, updating, storing and transmission. If a particular PLTC value is not required, a value that is otherwise not valid, such as “ABC”, will be assigned to indicate that any PLTC value is acceptable.

PLTD will represent the proposed elevation value, at which location when combined with the PLTB and PLTC values, the proposed latitude coordinate, PLAT, is proposed to be implemented, specified as an elevation value of the vehicle relative to sea level or some other standard to determine elevation, as used by the commonly accepted geographic coordinate system and/or other available instrumentation to represent the elevation of the vehicle, whether the vehicle is on land, on water, submerged in water, or above ground, specified with sufficient precision to support the method of travel for which information is being monitored and the frequency of information gathering, updating, storing and transmission. If a particular PLTD value is not required, a value that is otherwise not valid, such as “ABC”, will be assigned to indicate that any PLTD value is acceptable.

PLTP will represent the relative priority of determining when the change in latitude coordinate, PLAT, will occur, with a value to indicate if the change in latitude coordinate of the vehicle is made at the first occurrence of the time reaching the PLTA value, the vehicle reaching the location identified in the combination of the PLTB, PLTC, and PLTD values, or both the reaching of the time specified in the PLTA record and the location identified in the combination of the PLTB, PLTC, and PLTD values.

PLON will represent the proposed longitude coordinate of the vehicle as used by the commonly accepted geographic coordinate system and/or other available instrumentation to represent the location of the vehicle relative to its position on earth as determined by input, either from the operator of the vehicle, someone authorized to propose changes, or an automated system, to indicate any proposed change in the longitude coordinate of the vehicle from the current longitude coordinate, CLOC, whether the vehicle is on land, on water, submerged in water, or above ground, specified with sufficient precision to support the method of travel for which information is being monitored and the frequency of information gathering, updating, storing and transmission.

PLNA will represent the proposed time at which the proposed longitude coordinate, as specified in the PLON record, is proposed to begin to be implemented, specified as a future time as used by the commonly accepted geographic coordinate system and/or other available instrumentation, specified with sufficient precision to support the method of travel for which information is being monitored and the frequency of information gathering and updating. If a particular PLNA value is not required, a value that is otherwise not valid, such as “ABC”, will be assigned to indicate that any PLNA value is acceptable.

PLNB will represent the proposed latitude coordinate, at which location when combined with the PLNC and PLND values, the proposed longitude coordinate, PLON, is proposed to be implemented, specified as a latitude coordinate of the vehicle, as used by the commonly accepted geographic coordinate system and/or other available instrumentation to represent the location of the vehicle relative to its position on earth whether the vehicle is on land, on water, submerged in water, or above ground, specified with sufficient precision to support the method of travel for which information is being monitored and the frequency of information gathering, updating, storing and transmission. If a particular PLNB value is not required, a value that is otherwise not valid, such as “ABC”, will be assigned to indicate that any PLNB value is acceptable.

PLNC will represent the proposed longitude coordinate, at which location when combined with the PLNB and PLND values, the proposed longitude coordinate, PLON, is proposed to be implemented, specified as a longitude coordinate of the vehicle, as used by the commonly accepted geographic coordinate system and/or other available instrumentation to represent the location of the vehicle relative to its position on earth whether the vehicle is on land, on water, submerged in water, or above ground, specified with sufficient precision to support the method of travel for which information is being monitored and the frequency of information gathering, updating, storing and transmission. If a particular PLNC value is not required, a value that is otherwise not valid, such as “ABC”, will be assigned to indicate that any PLNC value is acceptable.

PLND will represent the proposed elevation value, at which location when combined with the PLNB and PLNC values, the proposed longitude coordinate, PLON, is proposed to be implemented, specified as an elevation value of the vehicle relative to sea level or some other standard to determine elevation, as used by the commonly accepted geographic coordinate system and/or other available instrumentation to represent the elevation of the vehicle, whether the vehicle is on land, on water, submerged in water, or above ground, specified with sufficient precision to support the method of travel for which information is being monitored and the frequency of information gathering, updating, storing and transmission. If a particular PLND value is not required, a value that is otherwise not valid, such as “ABC”, will be assigned to indicate that any PLND value is acceptable.

PLNP will represent the relative priority of determining when the change in longitude coordinate, PLON, will occur, with a value to indicate if the change in longitude coordinate of the vehicle is made at the first occurrence of the time reaching the PLNA value, the vehicle reaching the location identified in the combination of the PLNB, PLNC, and PLND values, or both the reaching of the time specified in the PLNA record and the location identified in the combination of the PLNB, PLNC, and PLND values.

PELV will represent the proposed elevation value of the vehicle specified as an elevation value of the vehicle relative to sea level or some other standard to determine elevation, as used by the commonly accepted geographic coordinate system and/or other available instrumentation to represent the elevation of the vehicle, whether the vehicle is on land, on water, submerged in water, or above ground, specified with sufficient precision to support the method of travel for which information is being monitored and the frequency of information gathering, updating, storing and transmission, as determined by input, either from the operator of the vehicle, someone authorized to propose changes, or an automated system, to indicate any proposed change in the elevation value of the vehicle from the current elevation value.

PELA will represent the proposed time at which the proposed elevation value, as specified in the PELV record, is proposed to begin to be implemented, specified as a future time as used by the commonly accepted geographic coordinate system and/or other available instrumentation, specified with sufficient precision to support the method of travel for which information is being monitored and the frequency of information gathering and updating. If a particular PELA value is not required, a value that is otherwise not valid, such as “ABC”, will be assigned to indicate that any PELA value is acceptable.

PELB will represent the proposed latitude coordinate, at which location when combined with the PELC and PELD values, the proposed elevation value, PELV, is proposed to be implemented, specified as a latitude coordinate of the vehicle, as used by the commonly accepted geographic coordinate system and/or other available instrumentation to represent the location of the vehicle relative to its position on earth whether the vehicle is on land, on water, submerged in water, or above ground, specified with sufficient precision to support the method of travel for which information is being monitored and the frequency of information gathering, updating, storing and transmission. If a particular PELB value is not required, a value that is otherwise not valid, such as “ABC”, will be assigned to indicate that any PELB value is acceptable.

PELC will represent the proposed longitude coordinate, at which location when combined with the PELB and PELD values, the proposed elevation value, PELV, is proposed to be implemented, specified as a longitude coordinate of the vehicle, as used by the commonly accepted geographic coordinate system and/or other available instrumentation to represent the location of the vehicle relative to its position on earth whether the vehicle is on land, on water, submerged in water, or above ground, specified with sufficient precision to support the method of travel for which information is being monitored and the frequency of information gathering, updating, storing and transmission. If a particular PELC value is not required, a value that is otherwise not valid, such as “ABC”, will be assigned to indicate that any PELC value is acceptable.

PELD will represent the proposed elevation value, at which location when combined with the PELB and PELC values, the proposed elevation value, PELV, is proposed to be implemented, specified as an elevation value of the vehicle relative to sea level or some other standard to determine elevation, as used by the commonly accepted geographic coordinate system and/or other available instrumentation to represent the elevation of the vehicle, whether the vehicle is on land, on water, submerged in water, or above ground, specified with sufficient precision to support the method of travel for which information is being monitored and the frequency of information gathering, updating, storing and transmission. If a particular PELD value is not required, a value that is otherwise not valid, such as “ABC”, will be assigned to indicate that any PELD value is acceptable.

PELP will represent the relative priority of determining when the change in elevation value, PELV, will occur, with a value to indicate if the change in elevation value of the vehicle is made at the first occurrence of the time reaching the PELA value, the vehicle reaching the location identified in the combination of the PELB, PELC, and PELD values, or both the reaching of the time specified in the PELA record and the location identified in the combination of the PELB, PELC, and PELD values.

PTNB will represent the proposed absolute bearing of the vehicle relative to true geographical north, as determined by input, either from the operator of the vehicle, someone authorized to propose changes, or an automated system, to indicate any proposed change in the bearing relative to true geographical north of the vehicle from the current bearing relative to true geographical north, CTAB, whether the vehicle is on land, on water, submerged in water, or above ground, specified with sufficient precision to support the method of travel for which information is being monitored and the frequency of information gathering, updating, storing and transmission.

PTBA will represent the proposed time at which the proposed absolute bearing of the vehicle relative to true geographical north, as specified in the PTNB record, is proposed to begin to be implemented, specified as a future time as used by the commonly accepted geographic coordinate system and/or other available instrumentation, specified with sufficient precision to support the method of travel for which information is being monitored and the frequency of information gathering and updating. If a particular PTBA value is not required, a value that is otherwise not valid, such as “ABC”, will be assigned to indicate that any PTBA value is acceptable.

PTBB will represent the proposed latitude coordinate, at which location when combined with the PTBC and PTBD values, the proposed absolute bearing of the vehicle relative to true geographical north, PTNB, is proposed to be implemented, specified as a latitude coordinate of the vehicle, as used by the commonly accepted geographic coordinate system and/or other available instrumentation to represent the location of the vehicle relative to its position on earth whether the vehicle is on land, on water, submerged in water, or above ground, specified with sufficient precision to support the method of travel for which information is being monitored and the frequency of information gathering, updating, storing and transmission. If a particular PTBB value is not required, a value that is otherwise not valid, such as “ABC”, will be assigned to indicate that any PTBB value is acceptable.

PTBC will represent the proposed longitude coordinate, at which location when combined with the PTBB and PTBD values, the proposed absolute bearing of the vehicle relative to true geographical north, PTNB, is proposed to be implemented, specified as a longitude coordinate of the vehicle, as used by the commonly accepted geographic coordinate system and/or other available instrumentation to represent the location of the vehicle relative to its position on earth whether the vehicle is on land, on water, submerged in water, or above ground, specified with sufficient precision to support the method of travel for which information is being monitored and the frequency of information gathering, updating, storing and transmission. If a particular PTBC value is not required, a value that is otherwise not valid, such as “ABC”, will be assigned to indicate that any PTBC value is acceptable.

PTBD will represent the proposed elevation value, at which location when combined with the PTBB and PTBC values, the proposed absolute bearing of the vehicle relative to true geographical north, PTNB, is proposed to be implemented, specified as an elevation value of the vehicle relative to sea level or some other standard to determine elevation, as used by the commonly accepted geographic coordinate system and/or other available instrumentation to represent the elevation of the vehicle, whether the vehicle is on land, on water, submerged in water, or above ground, specified with sufficient precision to support the method of travel for which information is being monitored and the frequency of information gathering, updating, storing and transmission. If a particular PTBD value is not required, a value that is otherwise not valid, such as “ABC”, will be assigned to indicate that any PTBD value is acceptable.

PTBP will represent the relative priority of determining when the change in absolute bearing of the vehicle relative to true geographical north, PTNB will occur, with a value to indicate if the change in absolute bearing of the vehicle relative to true geographical north of the vehicle is made at the first occurrence of the time reaching the PTBA value, the vehicle reaching the location identified in the combination of the PTBB, PTBC, and PTBD values, or both the reaching of the time specified in the PTBA record and the location identified in the combination of the PTBB, PTBC, and PTBD values.

PMAB will represent the proposed absolute bearing of the vehicle relative to magnetic north, as determined by input, either from the operator of the vehicle, someone authorized to propose changes, or an automated system, to indicate any proposed change in the bearing relative to magnetic north of the vehicle from the current bearing relative to magnetic north, CMAB, whether the vehicle is on land, on water, submerged in water, or above ground, specified with sufficient precision to support the method of travel for which information is being monitored and the frequency of information gathering, updating, storing and transmission.

PMBA will represent the proposed time at which the proposed absolute bearing of the vehicle relative to magnetic north, as specified in the PMAB record, is proposed to begin to be implemented, specified as a future time as used by the commonly accepted geographic coordinate system and/or other available instrumentation, specified with sufficient precision to support the method of travel for which information is being monitored and the frequency of information gathering and updating. If a particular PMBA value is not required, a value that is otherwise not valid, such as “ABC”, will be assigned to indicate that any PMBA value is acceptable.

PMBB will represent the proposed latitude coordinate, at which location when combined with the PMBC and PMBD values, the proposed absolute bearing of the vehicle relative to magnetic north, PMAB, is proposed to be implemented, specified as a latitude coordinate of the vehicle, as used by the commonly accepted geographic coordinate system and/or other available instrumentation to represent the location of the vehicle relative to its position on earth whether the vehicle is on land, on water, submerged in water, or above ground, specified with sufficient precision to support the method of travel for which information is being monitored and the frequency of information gathering, updating, storing and transmission. If a particular PMBB value is not required, a value that is otherwise not valid, such as “ABC”, will be assigned to indicate that any PMBB value is acceptable.

PMBC will represent the proposed longitude coordinate, at which location when combined with the PMBB and PMBD values, the proposed absolute bearing of the vehicle relative to magnetic north, PMAB, is proposed to be implemented, specified as a longitude coordinate of the vehicle, as used by the commonly accepted geographic coordinate system and/or other available instrumentation to represent the location of the vehicle relative to its position on earth whether the vehicle is on land, on water, submerged in water, or above ground, specified with sufficient precision to support the method of travel for which information is being monitored and the frequency of information gathering, updating, storing and transmission. If a particular PMBC value is not required, a value that is otherwise not valid, such as “ABC”, will be assigned to indicate that any PMBC value is acceptable.

PMBD will represent the proposed elevation value, at which location when combined with the PMBB and PMBC values, the proposed absolute bearing of the vehicle relative to magnetic north, PMAB, is proposed to be implemented, specified as an elevation value of the vehicle relative to sea level or some other standard to determine elevation, as used by the commonly accepted geographic coordinate system and/or other available instrumentation to represent the elevation of the vehicle, whether the vehicle is on land, on water, submerged in water, or above ground, specified with sufficient precision to support the method of travel for which information is being monitored and the frequency of information gathering, updating, storing and transmission. If a particular PMBD value is not required, a value that is otherwise not valid, such as “ABC”, will be assigned to indicate that any PMBD value is acceptable.

PMBP will represent the relative priority of determining when the change in absolute bearing of the vehicle relative to magnetic north, PMAB, will occur, with a value to indicate if the change in absolute bearing of the vehicle relative to magnetic north is made at the first occurrence of the time reaching the PMBA value, the vehicle reaching the location identified in the combination of the PMBB, PMBC, and PMBD values, or both the reaching of the time specified in the PMBA record and the location identified in the combination of the PMBB, PMBC, and PMBD values.

PZEN will represent the proposed zenith angle of the motion of the vehicle as determined by input, either from the operator of the vehicle, someone authorized to propose changes, or an automated system, to indicate any proposed change in the zenith angle of the motion of the vehicle from the current zenith angle of the motion of the vehicle, CZEN, whether the vehicle is on land, on water, submerged in water, or above ground, specified with sufficient precision to support the method of travel for which information is being monitored and the frequency of information gathering, updating, storing and transmission.

PZNA will represent the proposed time at which the proposed zenith angle of the motion of the vehicle, as specified in the PZEN record, is proposed to begin to be implemented, specified as a future time as used by the commonly accepted geographic coordinate system and/or other available instrumentation, specified with sufficient precision to support the method of travel for which information is being monitored and the frequency of information gathering and updating. If a particular PZNA value is not required, a value that is otherwise not valid, such as “ABC”, will be assigned to indicate that any PZNA value is acceptable.

PZNB will represent the proposed latitude coordinate, at which location when combined with the PZNC and PZND values, the proposed zenith angle of the motion of the vehicle, PZEN, is proposed to be implemented, specified as a latitude coordinate of the vehicle, as used by the commonly accepted geographic coordinate system and/or other available instrumentation to represent the location of the vehicle relative to its position on earth whether the vehicle is on land, on water, submerged in water, or above ground, specified with sufficient precision to support the method of travel for which information is being monitored and the frequency of information gathering, updating, storing and transmission. If a particular PZNB value is not required, a value that is otherwise not valid, such as “ABC”, will be assigned to indicate that any PZNB value is acceptable.

PZNC will represent the proposed longitude coordinate, at which location when combined with the PZNB and PZND values, the proposed zenith angle of the motion of the vehicle, PZEN, is proposed to be implemented, specified as a longitude coordinate of the vehicle, as used by the commonly accepted geographic coordinate system and/or other available instrumentation to represent the location of the vehicle relative to its position on earth whether the vehicle is on land, on water, submerged in water, or above ground, specified with sufficient precision to support the method of travel for which information is being monitored and the frequency of information gathering, updating, storing and transmission. If a particular PZNC value is not required, a value that is otherwise not valid, such as “ABC”, will be assigned to indicate that any PZNC value is acceptable.

PZND will represent the proposed elevation value, at which location when combined with the PZNB and PZNC values, the proposed zenith angle of the motion of the vehicle, PZEN, is proposed to be implemented, specified as an elevation value of the vehicle relative to sea level or some other standard to determine elevation, as used by the commonly accepted geographic coordinate system and/or other available instrumentation to represent the elevation of the vehicle, whether the vehicle is on land, on water, submerged in water, or above ground, specified with sufficient precision to support the method of travel for which information is being monitored and the frequency of information gathering, updating, storing and transmission. If a particular PZND value is not required, a value that is otherwise not valid, such as “ABC”, will be assigned to indicate that any PZND value is acceptable.

PZNP will represent the relative priority of determining when the change in zenith angle of the motion of the vehicle, PZEN, will occur, with a value to indicate if the change in zenith angle of the motion of the vehicle is made at the first occurrence of the time reaching the PZNA value, the vehicle reaching the location identified in the combination of the PZNB, PZNC, and PZND values, or both the reaching of the time specified in the PZNA record and the location identified in the combination of the PZNB, PZNC, and PZND values.

PSPD will represent the proposed speed of the vehicle, as determined by input, either from the operator of the vehicle, someone authorized to propose changes, or an automated system, to indicate any proposed change in the speed of the vehicle from the current speed, CSPD, whether the vehicle is on land, on water, submerged in water, or above ground, specified with sufficient precision to support the method of travel for which information is being monitored and the frequency of information gathering, updating, storing and transmission.

PSDA will represent the proposed time at which the proposed speed, as specified in the PSPD record, is proposed to begin to be implemented, specified as a future time as used by the commonly accepted geographic coordinate system and/or other available instrumentation, specified with sufficient precision to support the method of travel for which information is being monitored and the frequency of information gathering and updating. If a particular PSDA value is not required, a value that is otherwise not valid, such as “ABC”, will be assigned to indicate that any PSDA value is acceptable.

PSDB will represent the proposed latitude coordinate, at which location when combined with the PSDC and PSDD values, the proposed speed, PSPD, is proposed to be implemented, specified as a latitude coordinate of the vehicle, as used by the commonly accepted geographic coordinate system and/or other available instrumentation to represent the location of the vehicle relative to its position on earth whether the vehicle is on land, on water, submerged in water, or above ground, specified with sufficient precision to support the method of travel for which information is being monitored and the frequency of information gathering, updating, storing and transmission. If a particular PSDB value is not required, a value that is otherwise not valid, such as “ABC”, will be assigned to indicate that any PSDB value is acceptable.

PSDC will represent the proposed longitude coordinate, at which location when combined with the PSDB and PSDD values, the proposed speed, PSPD, is proposed to be implemented, specified as a longitude coordinate of the vehicle, as used by the commonly accepted geographic coordinate system and/or other available instrumentation to represent the location of the vehicle relative to its position on earth whether the vehicle is on land, on water, submerged in water, or above ground, specified with sufficient precision to support the method of travel for which information is being monitored and the frequency of information gathering, updating, storing and transmission. If a particular PSDC value is not required, a value that is otherwise not valid, such as “ABC”, will be assigned to indicate that any PSDC value is acceptable.

PSDD will represent the proposed elevation value, at which location when combined with the PSDB and PSDC values, the proposed speed, PSPD, is proposed to be implemented, specified as an elevation value of the vehicle relative to sea level or some other standard to determine elevation, as used by the commonly accepted geographic coordinate system and/or other available instrumentation to represent the elevation of the vehicle, whether the vehicle is on land, on water, submerged in water, or above ground, specified with sufficient precision to support the method of travel for which information is being monitored and the frequency of information gathering, updating, storing and transmission. If a particular PSDD value is not required, a value that is otherwise not valid, such as “ABC”, will be assigned to indicate that any PSDD value is acceptable.

PSDP will represent the relative priority of determining when the change in speed will occur, with a value to indicate if the change in speed of the vehicle, PSPD, is made at the first occurrence of the time reaching the PSDA value, the vehicle reaching the location identified in the combination of the PSDB, PSDC, and PSDD values, or both the reaching of the time specified in the PSDA record and the location identified in the combination of the PSDB, PSDC, and PSDD values.

PROL will represent the proposed degree of roll, or the rotation along the roll axis of the vehicle, from the vehicle's predefined steady equilibrium state for roll, as determined by input, either from the operator of the vehicle, someone authorized to propose changes, or an automated system, to indicate any proposed change in the roll of the vehicle from the current roll, CROL, whether the vehicle is on land, on water, submerged in water, or above ground, specified with sufficient precision to support the method of travel for which information is being monitored and the frequency of information gathering, updating, storing and transmission.

PRLA will represent the proposed time at which the proposed roll, as specified in the PROL record, is proposed to begin to be implemented, specified as a future time as used by the commonly accepted geographic coordinate system and/or other available instrumentation, specified with sufficient precision to support the method of travel for which information is being monitored and the frequency of information gathering and updating. If a particular PRLA value is not required, a value that is otherwise not valid, such as “ABC”, will be assigned to indicate that any PRLA value is acceptable.

PRLB will represent the proposed latitude coordinate, at which location when combined with the PRLC and PRLD values, the proposed roll, PROL, is proposed to be implemented, specified as a latitude coordinate of the vehicle, as used by the commonly accepted geographic coordinate system and/or other available instrumentation to represent the location of the vehicle relative to its position on earth whether the vehicle is on land, on water, submerged in water, or above ground, specified with sufficient precision to support the method of travel for which information is being monitored and the frequency of information gathering, updating, storing and transmission. If a particular PRLB value is not required, a value that is otherwise not valid, such as “ABC”, will be assigned to indicate that any PRLB value is acceptable.

PRLC will represent the proposed longitude coordinate, at which location when combined with the PRLB and PRLD values, the proposed roll, PROL, is proposed to be implemented, specified as a longitude coordinate of the vehicle, as used by the commonly accepted geographic coordinate system and/or other available instrumentation to represent the location of the vehicle relative to its position on earth whether the vehicle is on land, on water, submerged in water, or above ground, specified with sufficient precision to support the method of travel for which information is being monitored and the frequency of information gathering, updating, storing and transmission. If a particular PRLC value is not required, a value that is otherwise not valid, such as “ABC”, will be assigned to indicate that any PRLC value is acceptable.

PRLD will represent the proposed elevation value, at which location when combined with the PRLB and PRLC values, the proposed roll, PROL, is proposed to be implemented, specified as an elevation value of the vehicle relative to sea level or some other standard to determine elevation, as used by the commonly accepted geographic coordinate system and/or other available instrumentation to represent the elevation of the vehicle, whether the vehicle is on land, on water, submerged in water, or above ground, specified with sufficient precision to support the method of travel for which information is being monitored and the frequency of information gathering, updating, storing and transmission. If a particular PRLD value is not required, a value that is otherwise not valid, such as “ABC”, will be assigned to indicate that any PRLD value is acceptable.

PRLP will represent the relative priority of determining when the change in roll, PROL, will occur, with a value to indicate if the change in roll of the vehicle is made at the first occurrence of the time reaching the PRLA value, the vehicle reaching the location identified in the combination of the PRLB, PRLC, and PRLD values, or both the reaching of the time specified in the PRLA record and the location identified in the combination of the PRLB, PRLC, and PRLD values.

PPTC will represent the proposed degree of pitch, or rotation along the pitch axis of the vehicle, from the vehicle's predefined steady equilibrium state for pitch, as determined by input, either from the operator of the vehicle, someone authorized to propose changes, or an automated system, to indicate any proposed change in the pitch of the vehicle from the current pitch, CPTC, whether the vehicle is on land, on water, submerged in water, or above ground, specified with sufficient precision to support the method of travel for which information is being monitored and the frequency of information gathering, updating, storing and transmission.

PPCA will represent the proposed time at which the proposed pitch, as specified in the PPTC record, is proposed to begin to be implemented, specified as a future time as used by the commonly accepted geographic coordinate system and/or other available instrumentation, specified with sufficient precision to support the method of travel for which information is being monitored and the frequency of information gathering and updating. If a particular PPCA value is not required, a value that is otherwise not valid, such as “ABC”, will be assigned to indicate that any PPCA value is acceptable.

PPCB will represent the proposed latitude coordinate, at which location when combined with the PPCC and PPCD values, the proposed pitch, PPTC, is proposed to be implemented, specified as a latitude coordinate of the vehicle, as used by the commonly accepted geographic coordinate system and/or other available instrumentation to represent the location of the vehicle relative to its position on earth whether the vehicle is on land, on water, submerged in water, or above ground, specified with sufficient precision to support the method of travel for which information is being monitored and the frequency of information gathering, updating, storing and transmission. If a particular PPCB value is not required, a value that is otherwise not valid, such as “ABC”, will be assigned to indicate that any PPCB value is acceptable.

PPCC will represent the proposed longitude coordinate, at which location when combined with the PPCB and PPCD values, the proposed pitch, PPTC, is proposed to be implemented, specified as a longitude coordinate of the vehicle, as used by the commonly accepted geographic coordinate system and/or other available instrumentation to represent the location of the vehicle relative to its position on earth whether the vehicle is on land, on water, submerged in water, or above ground, specified with sufficient precision to support the method of travel for which information is being monitored and the frequency of information gathering, updating, storing and transmission. If a particular PPCC value is not required, a value that is otherwise not valid, such as “ABC”, will be assigned to indicate that any PPCC value is acceptable.

PPCD will represent the proposed elevation value, at which location when combined with the PPCB and PPCC values, the proposed pitch, PPTC, is proposed to be implemented, specified as an elevation value of the vehicle relative to sea level or some other standard to determine elevation, as used by the commonly accepted geographic coordinate system and/or other available instrumentation to represent the elevation of the vehicle, whether the vehicle is on land, on water, submerged in water, or above ground, specified with sufficient precision to support the method of travel for which information is being monitored and the frequency of information gathering, updating, storing and transmission. If a particular PPCD value is not required, a value that is otherwise not valid, such as “ABC”, will be assigned to indicate that any PPCD value is acceptable.

PPCP will represent the relative priority of determining when the change in pitch, PPTC, will occur, with a value to indicate if the change in pitch of the vehicle is made at the first occurrence of the time reaching the PPCA value, the vehicle reaching the location identified in the combination of the PPCB, PPCC, and PPCD values, or both the reaching of the time specified in the PPCA record and the location identified in the combination of the PPCB, PPCC, and PPCD values.

PYAW will represent the proposed degree of yaw, or the rotation along the yaw axis of the vehicle, from the vehicle's predefined steady equilibrium state for yaw, as determined by input, either from the operator of the vehicle, someone authorized to propose changes, or an automated system, to indicate any proposed change in the yaw of the vehicle from the current yaw, whether the vehicle is on land, on water, submerged in water, or above ground, specified with sufficient precision to support the method of travel for which information is being monitored and the frequency of information gathering, updating, storing and transmission.

PYWA will represent the proposed time at which the proposed yaw, as specified in the PYAW record, is proposed to begin to be implemented, specified as a future time as used by the commonly accepted geographic coordinate system and/or other available instrumentation, specified with sufficient precision to support the method of travel for which information is being monitored and the frequency of information gathering and updating. If a particular PYWA value is not required, a value that is otherwise not valid, such as “ABC”, will be assigned to indicate that any PYWA value is acceptable.

PYWB will represent the proposed latitude coordinate, at which location when combined with the PYWC and PYWD values, the proposed yaw, PYAW, is proposed to be implemented, specified as a latitude coordinate of the vehicle, as used by the commonly accepted geographic coordinate system and/or other available instrumentation to represent the location of the vehicle relative to its position on earth whether the vehicle is on land, on water, submerged in water, or above ground, specified with sufficient precision to support the method of travel for which information is being monitored and the frequency of information gathering, updating, storing and transmission. If a particular PYWB value is not required, a value that is otherwise not valid, such as “ABC”, will be assigned to indicate that any PYWB value is acceptable.

PYWC will represent the proposed longitude coordinate, at which location when combined with the PYWB and PYWD values, the proposed yaw, PYAW, is proposed to be implemented, specified as a longitude coordinate of the vehicle, as used by the commonly accepted geographic coordinate system and/or other available instrumentation to represent the location of the vehicle relative to its position on earth whether the vehicle is on land, on water, submerged in water, or above ground, specified with sufficient precision to support the method of travel for which information is being monitored and the frequency of information gathering, updating, storing and transmission. If a particular PYWC value is not required, a value that is otherwise not valid, such as “ABC”, will be assigned to indicate that any PYWC value is acceptable.

PYWD will represent the proposed elevation value, at which location when combined with the PYWB and PYWC values, the proposed yaw, PYAW, is proposed to be implemented, specified as an elevation value of the vehicle relative to sea level or some other standard to determine elevation, as used by the commonly accepted geographic coordinate system and/or other available instrumentation to represent the elevation of the vehicle, whether the vehicle is on land, on water, submerged in water, or above ground, specified with sufficient precision to support the method of travel for which information is being monitored and the frequency of information gathering, updating, storing and transmission. If a particular PYWD value is not required, a value that is otherwise not valid, such as “ABC”, will be assigned to indicate that any PYWD value is acceptable.

PYWP will represent the relative priority of determining when the change in yaw, PYAW, will occur, with a value to indicate if the change in yaw of the vehicle is made at the first occurrence of the time reaching the PYWA value, the vehicle reaching the location identified in the combination of the PYWB, PYWC, and PYWD values, or both the reaching of the time specified in the PYWA record and the location identified in the combination of the PYWB, PYWC, and PYWD values.

PACC will represent the proposed acceleration rate of the vehicle, as determined by input, either from the operator of the vehicle, someone authorized to propose changes, or an automated system, to indicate any proposed change in the acceleration rate of the vehicle from the current acceleration rate, whether the vehicle is on land, on water, submerged in water, or above ground, specified with sufficient precision to support the method of travel for which information is being monitored and the frequency of information gathering, updating, storing and transmission.

PALA will represent the proposed time at which the proposed acceleration rate, as specified in the PACC record, is proposed to begin to be implemented, specified as a future time as used by the commonly accepted geographic coordinate system and/or other available instrumentation, specified with sufficient precision to support the method of travel for which information is being monitored and the frequency of information gathering and updating. If a particular PALA value is not required, a value that is otherwise not valid, such as “ABC”, will be assigned to indicate that any PALA value is acceptable.

PALB will represent the proposed latitude coordinate, at which location when combined with the PALC and PALD values, the proposed acceleration rate, PACC, is proposed to be implemented, specified as a latitude coordinate of the vehicle, as used by the commonly accepted geographic coordinate system and/or other available instrumentation to represent the location of the vehicle relative to its position on earth whether the vehicle is on land, on water, submerged in water, or above ground, specified with sufficient precision to support the method of travel for which information is being monitored and the frequency of information gathering, updating, storing and transmission. If a particular PALB value is not required, a value that is otherwise not valid, such as “ABC”, will be assigned to indicate that any PALB value is acceptable.

PALC will represent the proposed longitude coordinate, at which location when combined with the PALB and PALD values, the proposed acceleration rate, PACC, is proposed to be implemented, specified as a longitude coordinate of the vehicle, as used by the commonly accepted geographic coordinate system and/or other available instrumentation to represent the location of the vehicle relative to its position on earth whether the vehicle is on land, on water, submerged in water, or above ground, specified with sufficient precision to support the method of travel for which information is being monitored and the frequency of information gathering, updating, storing and transmission. If a particular PALC value is not required, a value that is otherwise not valid, such as “ABC”, will be assigned to indicate that any PALC value is acceptable.

PALD will represent the proposed elevation value, at which location when combined with the PALB and PALC values, the proposed acceleration rate, PACC, is proposed to be implemented, specified as an elevation value of the vehicle relative to sea level or some other standard to determine elevation, as used by the commonly accepted geographic coordinate system and/or other available instrumentation to represent the elevation of the vehicle, whether the vehicle is on land, on water, submerged in water, or above ground, specified with sufficient precision to support the method of travel for which information is being monitored and the frequency of information gathering, updating, storing and transmission. If a particular PALD value is not required, a value that is otherwise not valid, such as “ABC”, will be assigned to indicate that any PALD value is acceptable.

PALP will represent the relative priority of determining when the change in acceleration rate, PACC, will occur, with a value to indicate if the change in acceleration rate of the vehicle is made at the first occurrence of the time reaching the PALA value, the vehicle reaching the location identified in the combination of the PALB, PALC, and PALD values, or both the reaching of the time specified in the PALA record and the location identified in the combination of the PALB, PALC, and PALD values.

ILAT will represent the indicated change in latitude coordinate, which does not appear related to a PLAT, PLON, PTNB, PMAB, PZEN, PSPD, PROL, PPTC, PYAW or PACC record or records to indicate the planned change, or other evidence of this being part of or related to a pre-planned course, speed, heading, or position change, but instead shows itself through either an unscheduled change in the latitudinal or longitudinal direction, the true north or magnetic bearing of the vehicle, the zenith angle of the vehicle, the speed of the vehicle, the roll, pitch, or yaw of the vehicle, or the acceleration rate of the vehicle as compared to the prior readings related to the vehicle, or through an intentional indication, either sensory or otherwise, of an intention to alter the latitudinal course of the vehicle from the prior expected latitudinal course. This will apply whether the vehicle is on land, on water, submerged in water, or above ground, and specified with sufficient precision to support the method of travel for which information is being monitored and the frequency of information gathering, updating, storing and transmission.

ILOC will represent the indicated change in longitude coordinate, which does not appear related to a PLAT, PLON, PTNB, PMAB, PZEN, PSPD, PROL, PPTC, PYAW or PACC record or records to indicate the planned change, or other evidence of this being part of or related to a pre-planned course, speed, heading, or position change, but instead shows itself through either an unscheduled change in the latitudinal or longitudinal direction, the true north or magnetic bearing of the vehicle, the zenith angle of the vehicle, the speed of the vehicle, the roll, pitch, or yaw of the vehicle, or the acceleration rate of the vehicle as compared to the prior readings related to the vehicle, or through an intentional indication, either sensory or otherwise, of an intention to alter the longitudinal course of the vehicle from the prior expected longitudinal course. This will apply whether the vehicle is on land, on water, submerged in water, or above ground, and specified with sufficient precision to support the method of travel for which information is being monitored and the frequency of information gathering, updating, storing and transmission.

IELV will represent the indicated change in elevation, which does not appear related to a PLAT, PLON, PTNB, PMAB, PZEN, PSPD, PROL, PPTC, PYAW or PACC record or records to indicate the planned change, or other evidence of this being part of or related to a pre-planned course, speed, heading, or position change, but instead shows itself through either an unscheduled change in the latitudinal or longitudinal direction, the true north or magnetic bearing of the vehicle, the zenith angle of the vehicle, the speed of the vehicle, the roll, pitch, or yaw of the vehicle, or the acceleration rate of the vehicle as compared to the prior readings related to the vehicle, or through an intentional indication, either sensory or otherwise, of an intention to alter the elevation of the vehicle from the prior expected elevation course. This will apply whether the vehicle is on land, on water, submerged in water, or above ground, and specified with sufficient precision to support the method of travel for which information is being monitored and the frequency of information gathering, updating, storing and transmission.

ITAB will represent the indicated change to the heading of the vehicle related to true geographical north, which does not appear related to a PLAT, PLON, PTNB, PMAB, PZEN, PSPD, PROL, PPTC, PYAW or PACC record or records to indicate the planned change, or other evidence of this being part of or related to a pre-planned course, speed, heading, or position change, but instead shows itself through either an unscheduled change in the latitudinal or longitudinal direction, the true north or magnetic bearing of the vehicle, the zenith angle of the vehicle, the speed of the vehicle, the roll, pitch, or yaw of the vehicle, or the acceleration rate of the vehicle as compared to the prior readings related to the vehicle, or through an intentional indication, either sensory or otherwise, of an intention to alter the heading of the vehicle relative to true geographical north from the prior expected heading of the vehicle relative to true geographical north. This will apply whether the vehicle is on land, on water, submerged in water, or above ground, and specified with sufficient precision to support the method of travel for which information is being monitored and the frequency of information gathering, updating, storing and transmission.

IMAB will represent the indicated change to the heading of the vehicle relative to magnetic north, which does not appear related to a PLAT, PLON, PTNB, PMAB, PZEN, PSPD, PROL, PPTC, PYAW or PACC record or records to indicate the planned change, or other evidence of this being part of or related to a pre-planned course, speed, heading, or position change, but instead shows itself through either an unscheduled change in the latitudinal or longitudinal direction, the true north or magnetic bearing of the vehicle, the zenith angle of the vehicle, the speed of the vehicle, the roll, pitch, or yaw of the vehicle, or the acceleration rate of the vehicle as compared to the prior readings related to the vehicle, or through an intentional indication, either sensory or otherwise, of an intention to alter the heading of the vehicle relative to magnetic north from the prior expected heading of the vehicle relative to magnetic north. This will apply whether the vehicle is on land, on water, submerged in water, or above ground, and specified with sufficient precision to support the method of travel for which information is being monitored and the frequency of information gathering, updating, storing and transmission.

IZEN will represent the indicated change to the zenith angle of the motion of the vehicle, which does not appear related to a PLAT, PLON, PTNB, PMAB, PZEN, PSPD, PROL, PPTC, PYAW or PACC record or records to indicate the planned change, or other evidence of this being part of or related to a pre-planned course, speed, heading, or position change, but instead shows itself through either an unscheduled change in the latitudinal or longitudinal direction, the true north or magnetic bearing of the vehicle, the zenith angle of the vehicle, the speed of the vehicle, the roll, pitch, or yaw of the vehicle, or the acceleration rate of the vehicle as compared to the prior readings related to the vehicle, or through an intentional indication, either sensory or otherwise, of an intention to alter the zenith angle of motion of the vehicle from the prior expected zenith angle of the motion of the vehicle. This will apply whether the vehicle is on land, on water, submerged in water, or above ground, and specified with sufficient precision to support the method of travel for which information is being monitored and the frequency of information gathering, updating, storing and transmission.

ISPD will represent the indicated change in the speed of the vehicle, which does not appear related to a PLAT, PLON, PTNB, PMAB, PZEN, PSPD, PROL, PPTC, PYAW or PACC record or records to indicate the planned change, or other evidence of this being part of or related to a pre-planned course, speed, heading, or position change, but instead shows itself through either an unscheduled change in the latitudinal or longitudinal direction, the true north or magnetic bearing of the vehicle, the zenith angle of the vehicle, the speed of the vehicle, the roll, pitch, or yaw of the vehicle, or the acceleration rate of the vehicle as compared to the prior readings related to the vehicle, or through an intentional indication, either sensory or otherwise, of an intention to alter the speed of the vehicle from the prior expected speed. This will apply whether the vehicle is on land, on water, submerged in water, or above ground, and specified with sufficient precision to support the method of travel for which information is being monitored and the frequency of information gathering, updating, storing and transmission.

IROL will represent the indicated change in the degree of roll, or the rotation along the roll axis of the vehicle from the vehicle's predefined steady equilibrium state for roll, which does not appear related to a PLAT, PLON, PTNB, PMAB, PZEN, PSPD, PROL, PPTC, PYAW or PACC record or records to indicate the planned change, or other evidence of this being part of or related to a pre-planned course, speed, heading, or position change, but instead shows itself through either an unscheduled change in the latitudinal or longitudinal direction, the true north or magnetic bearing of the vehicle, the zenith angle of the vehicle, the speed of the vehicle, the roll, pitch, or yaw of the vehicle, or the acceleration rate of the vehicle as compared to the prior readings related to the vehicle, or through an intentional indication, either sensory or otherwise, of an intention to alter the degree of roll of the vehicle from the prior expected degree of roll. This will apply whether the vehicle is on land, on water, submerged in water, or above ground, and specified with sufficient precision to support the method of travel for which information is being monitored and the frequency of information gathering, updating, storing and transmission.

IPTC will represent the indicated change in the degree of pitch, or rotation along the pitch axis of the vehicle from the vehicle's predefined steady equilibrium state for pitch, which does not appear related to a PLAT, PLON, PTNB, PMAB, PZEN, PSPD, PROL, PPTC, PYAW or PACC record or records to indicate the planned change, or other evidence of this being part of or related to a pre-planned course, speed, heading, or position change, but instead shows itself through either an unscheduled change in the latitudinal or longitudinal direction, the true north or magnetic bearing of the vehicle, the zenith angle of the vehicle, the speed of the vehicle, the roll, pitch, or yaw of the vehicle, or the acceleration rate of the vehicle as compared to the prior readings related to the vehicle, or through an intentional indication, either sensory or otherwise, of an intention to alter the degree of pitch of the vehicle from the prior expected degree of pitch. This will apply whether the vehicle is on land, on water, submerged in water, or above ground, and specified with sufficient precision to support the method of travel for which information is being monitored and the frequency of information gathering, updating, storing and transmission.

IYAW will represent the indicated change in the degree of yaw, or the rotation along the yaw axis of the vehicle from the vehicle's predefined steady equilibrium state for yaw, which does not appear related to a PLAT, PLON, PTNB, PMAB, PZEN, PSPD, PROL, PPTC, PYAW or PACC record or records to indicate the planned change, or other evidence of this being part of or related to a pre-planned course, speed, heading, or position change, but instead shows itself through either an unscheduled change in the latitudinal or longitudinal direction, the true north or magnetic bearing of the vehicle, the zenith angle of the vehicle, the speed of the vehicle, the roll, pitch, or yaw of the vehicle, or the acceleration rate of the vehicle as compared to the prior readings related to the vehicle, or through an intentional indication, either sensory or otherwise, of an intention to alter the degree of yaw of the vehicle from the prior expected degree of yaw. This will apply whether the vehicle is on land, on water, submerged in water, or above ground, and specified with sufficient precision to support the method of travel for which information is being monitored and the frequency of information gathering, updating, storing and transmission.

IACC will represent the indicated change in the acceleration rate of the vehicle, which does not appear related to a PLAT, PLON, PTNB, PMAB, PZEN, PSPD, PROL, PPTC, PYAW or PACC record or records to indicate the planned change, or other evidence of this being part of or related to a pre-planned course, speed, heading, or position change, but instead shows itself through either an unscheduled change in the latitudinal or longitudinal direction, the true north or magnetic bearing of the vehicle, the zenith angle of the vehicle, the speed of the vehicle, the roll, pitch, or yaw of the vehicle, or the acceleration rate of the vehicle as compared to the prior readings related to the vehicle, or through an intentional indication, either sensory or otherwise, of an intention to alter the acceleration rate of the vehicle from the prior expected acceleration rate. This will apply whether the vehicle is on land, on water, submerged in water, or above ground, and specified with sufficient precision to support the method of travel for which information is being monitored and the frequency of information gathering, updating, storing and transmission.

### CONCLUSION

The ability for vehicles of different types, from various manufacturers, with various capabilities, and serving various purposes to communicate with each other as well as with other services designed to receive, store, process and transmit this information, will provide significant potential for improved communication among vehicles, provide advanced notice of intended and unintended courses and changes to courses, provide notice of environmental considerations such as upcoming inclement weather or similar challenges, and provide additional information for the safe operation of various vehicles, whether operated by a human operator, operated autonomously, or a combination of both. The ability of vehicles to assemble, store, transmit, and receive information about the current, proposed, and indicated location, heading, speed, and other data available from other vehicles, will allow for improved decision making, whether by a human, in an automated fashion, or a combination of both. Providing and receiving this data will allow for better use of the paths of vehicles to avoid congestion, prevent collisions, avoid unsuitable or undesirable weather, and to better support future innovations in the operation of vehicles of all sorts. But to accomplish this, there must be a high speed and highly reliable method of communication, which is best accomplished by a standard for the handling of such information.

The standard for data elements contained herein will provide such a standard, allowing vehicles of all kinds, from many manufacturers, and meant for various areas of operations such as below the water, on the water, on the ground and above the ground, to all take advantage of the capabilities that will come from a robust method of the creation of data, the storage and transmission of that data, the processing of that data, and the ability to receive similar data from other vehicles and other services that will use this data. Although the description above contains many specificities, these should not be construed to limit the scope of the utility of this standard but as merely providing illustrations of some of several uses.

The invention claimed is:

1. A standard for the creation of data records to document the current, proposed, and indicated location, speed, heading, and environmental conditions regarding a vehicle, whether the vehicle is on land, on water, submerged in water, or above ground, specified with sufficient precision to support the method of travel for which information is being monitored and the frequency of information gathering, updating, storing, and transmission.

2. A standard for the creation of data records that document the current, proposed, and indicated location, speed, heading, and environmental conditions regarding a vehicle, whether the vehicle is on land, on water, submerged in water, or above ground, specified with sufficient precision to support the method of travel for which information is being monitored and the frequency of information gathering, updating, storing and transmission, which data can be then stored and/or transmitted for use by the operator of the vehicle, other vehicles, or other services that will process and utilize this data.

3. A standard for the storage, transmission, processing, and usage of data records to document the current, proposed, and indicated location, speed, heading, and environmental conditions regarding a vehicle, whether the vehicle is on land, on water, submerged in water, or above ground, specified with sufficient precision to support the method of travel for which information is being monitored and the frequency of information gathering, updating, storing and transmission, which data can be then stored, transmitted, processed, utilized, and retransmitted by the vehicle and/or the operator of the vehicle, other vehicles and/or the operators of those vehicles, or other services that will utilize this data for any number of purposes.
